(19) United States
(12) Patent Application Publication
(10) Pub. No.: US 2026/0127622 A1
(43) Pub. Date: May 7, 2026

(54) CARBON FOOTPRINT ACCOUNTING METHOD FOR PRODUCTION PROCESS OF CAMELLIA OIL

(71) Applicant: Central South University of Forestry and Technology, Changsha (CN)

(72) Inventors: Meifang Zhao, Changsha (CN); Mengde Sun, Nanning (CN); Yingying Xia, Nanning (CN); Peng Kang, Changsha (CN)

(21) Appl. No.: 19/208,551

(22) Filed: May 14, 2025

(30) Foreign Application Priority Data
Nov. 1, 2024 (CN) 202411547400.4

(51) Int. Cl. G06Q 30/018; G06F 17/11

(52) U.S. Cl. CPC G06Q 30/018; G06F 17/11

(57) ABSTRACT

A carbon footprint accounting method for a production process of camellia oil is provided, relating to field of forestry carbon neutrality; divides the production process of the camellia oil into an afforestation subsystem and a crude camellia oil subsystem; classifies inputs categories into energy, fertilizers, chemicals, materials, transportation, and waste treatment; accurately analyzes a carbon emission inventory throughout an entire life cycle of the production process of the camellia oil; and precisely defines a system boundary for carbon footprint accounting, therefore laying a foundation for subsequent carbon footprint accounting and facilitating an accurate calculation of carbon footprint of each subsystem. Then after collecting an inputs categories data of each subsystem, the carbon footprint of each subsystem is calculated to be cumulatively summed to obtain whole carbon footprint of the entire life cycle of the production process of the camellia oil.

### CROSS-REFERENCE TO RELATED APPLICATION

This application claims priority to Chinese Patent Application No. 202411547400.4, filed Nov. 1, 2024, which is herein incorporated by reference in its entirety.

### TECHNICAL FIELD

The disclosure relates to the field of forestry carbon neutrality, and more particularly to a carbon footprint accounting method for a production process of camellia oil.

### BACKGROUND

In recent years, global climate change has significantly affected forestry production and management of economic forest resources.

Carbon footprint accounting is a quantitative method used to evaluate/assess greenhouse gas emissions generated by a specific activity, product, or system throughout entire life cycle. For camellia oleifera woodland and camellia oil products, understanding carbon emissions in production processes is crucial for optimizing forestry production management, reducing carbon emissions, and promoting sustainable forestry development. Therefore, accounting carbon footprint of camellia oil from afforestation to crude camellia oil is of great practical significance.

The Chinese patent document with a publication No. CN115186519A discloses agricultural carbon footprint metering method and device based on variable system boundary scenarios, it performs carbon footprint accounting on wheat, corn, rice and apples, and specifically divides four stages of agricultural production, primary processing of agricultural products, transportation of agricultural products, and disposal of agricultural waste, but does not mention product planting and processing with long production cycle. The Chinese patent document with a publication No. CN114781135A discloses comprehensive estimation method and system for net greenhouse gas emissions of a regional agricultural planting system, and evaluates, by using a life cycle method, carbon dioxide (CO₂) emissions caused by agricultural management of wheat, corn, soybeans and rice at four stages of crop growth, namely sowing, management, harvesting, and straw returning; and the CO₂ emissions include CO₂ emissions caused by the uses of diesel, plastic films, pesticides and irrigation, productions and uses of fertilizers, and straw burning. The Chinese patent document with a publication No. CN118014393A discloses carbon footprint accounting method and system in economic forest improved variety breeding stage, it specifically discloses the carbon footprint accounting method for economic forest species from seedling cultivation to outplanting, which can provide assistance for carbon footprint accounting in an upstream supply chain of camellia oil production, but a problem of the carbon footprint accounting for an entire production process of the camellia oil remains to be solved. The Chinese patent document with a publication No. CN115619069A discloses carbon footprint accounting method and system for full life cycle of tea, and conducts carbon footprint accounting for the full life cycle of tea; the full life cycle of tea includes six stages of planting, processing, packaging, transportation, consumption and treatment. However, a production process of camellia oil is quite different from that of tea, and accounting ranges of available agricultural and forestry patents rarely relate to woody oil plants, leaving a gap in carbon footprint accounting of the camellia oil production, which needs to be filled urgently.

Pattara et al. accounted and analyzed five cases of olive oil products in Italy by carbon footprint method, and quantified greenhouse gas emissions related to olive planting and olive oil production (i.e., farm stage and factory stage). L. Fernández et al. quantified an environmental impact of producing one kilogram of unpackaged crude olive oil at farm and industrial stages by using survey data from 11 different types of olive production farms and 12 olive oil processing plants. Naderi et al. studied a carbon footprint and an environmental impact of apples from a production stage to a storage stage during a planting season in the year of 2018. Cabot et al. made a descriptive and critical review of a research status of 16 citrus fruit life cycle assessment (LCA) by a method decision-making and a crop cycle modeling, and found that most of research functional units used quality functional units and a system boundary of “from cradle to farm gate”.

Related researches on a carbon footprint of edible oil production mostly focus on production processes of oil products. Researches are not deep enough on the full life cycle process from “the cradle to farm gate”, are not clear about greenhouse gas emissions caused by specific front-end inputs and process steps, and cannot combine raw material production of oil products with product production of oil products, therefore resulting in inaccurate calculations.

### SUMMARY

To solve the aforementioned problems, the disclosure provides a carbon footprint accounting method for a production process of camellia oil so as to solve the problems in related art. Technical solutions provided by the disclosure are as follows.

Specifically, the carbon footprint accounting method for the production process of the camellia oil, includes the following steps:
(a) dividing subsystems and determining system boundaries, functional units, and trade-off criteria for carbon footprint in a life cycle of the production process of the camellia oil;
(b) determining carbon emission inventories of the respective subsystems based on production information of the production process of the camellia oil; analyzing the carbon emission inventories in the life cycle of the production process of the camellia oil; and determining an input inventory and an output inventory for each of phases;
(c) determining a calculation method, an allocation procedure, a data requirement, and emission factors for each of the subsystems;
in which the calculation method includes calculating total emissions of carbon dioxide equivalent (CO₂e) in the life cycle of the production process of the camellia oil as per the following formula (1) and formula (2):

$$E = {\sum }_{i} ( {G}_{i} \times {EF}_{ij} ) \qquad formula ( 1 )$$

where E represents emissions of a greenhouse gas j of the functional unit, Gᵢ represents activity usage data of an input i, and EFᵢⱼ represents an emission factor of the input i generating the greenhouse gas j;

$$CF = {\sum }_{j} ( {E}_{j} \times {GWP}_{j} ) \qquad formula ( 2 )$$

where, CF represents carbon footprint of the functional unit, Eⱼ represents the emissions of the greenhouse gas j of the functional unit, and GWPⱼ represents a global warming potential;
(d) conducting experiments, performing carbon balance consideration and continuously monitoring and tracking carbon emissions and carbon sequestration;
(e) constructing carbon emission accounting models by using an emission factor method, and obtaining the carbon footprint of the production process of the camellia oil by using the carbon emission accounting models of the respective subsystems; and
(f) conducting uncertainty and sensitivity analyses to determine emission proportions and data quality.
   in which the step (e) includes constructing the carbon emission accounting models for two subsystems namely an afforestation subsystem and a crude camellia oil subsystem and conducting carbon footprint accountings as follows:
   carbon footprint of the afforestation subsystem includes a total amount of greenhouse gas emissions caused by consumption of environmental resources and energy in all production processes within the afforestation subsystem expressed as the following formula (12):

$${E}_{forest} = \frac{{E}_{Ene} + {E}_{fer} + {E}_{cha} + {E}_{mat} + {E}_{T} + {E}_{was}}{( 1 - {W}_{1} )} \qquad formula ( 12 )$$

where, E_{forest} represents the carbon footprint of the afforestation subsystem, W₁ represents a loss rate of the afforestation subsystem, E_{Ene} represents CO₂ emissions corresponding to energy consumed by the functional unit, E_{cha} represents CO₂ emissions corresponding to chemicals consumed by the functional unit, Eₘₐₜ represents CO₂ emissions corresponding to materials consumed by the functional unit, E_{T} represents CO₂ emissions corresponding to electricity consumed by the functional unit, E_{was} represents carbon footprint during a waste treatment process, and E_{fer} represents CO₂ emission corresponding to fertilizers consumed by the functional unit;
carbon footprint of the crude camellia oil subsystem includes a total amount of greenhouse gas emissions caused by consumption of environmental resources and energy in all production processes within the crude camellia oil subsystem expressed as the following formula (13):

$${E}_{oil} = \frac{{E}_{Ene} + {E}_{fer} + {E}_{cha} + {E}_{mat} + {E}_{T} + {E}_{was}}{( 1 - {W}_{2} )} \qquad formula ( 13 )$$

where, Eₒᵢₗ represents the carbon footprint of the crude camellia oil subsystem, and W₂ represents a loss rate of the crude camellia oil subsystem; and
for the camellia oil, carbon footprint for a product of the camellia oil includes a total amount of greenhouse gas emissions caused by consumption of environmental resources and energy during a process of producing one ton of crude camellia oil expressed as the following formula (14):

$${E}_{FU} = \frac{{E}_{total}}{P} \qquad formula ( 14 )$$

where, E_{FU} represents carbon footprint of one functional unit, Eₜₒₜₐₗ represents total carbon footprint of the production process of the camellia oil, and P represents a total mass of product of camellia oil.

In an embodiment, in the step (a), the system boundaries include all processes in the life cycle of the production process of the camellia oil from camellia oleifera planting to crude camellia oil outcome, including the afforestation subsystem from a cradle to a woodland gate, and the crude camellia oil subsystem from the woodland gate to an oil mill gate;
in which the afforestation subsystem includes a production process of fresh camellia oleifera fruits from the cradle to the woodland gate, including: a preparation and planting stage, a young forest nurturing stage, a mature forest management stage, and a camellia oleifera fruit harvesting stage; and
in which the crude camellia oil subsystem includes the production process of the camellia oil from the woodland gate to the oil mill gate, including: a pre-treatment stage, a camellia oil extraction stage and a camellia oil refining stage.

In an embodiment, for the afforestation subsystem, an objective is to generate a detailed inventory for camellia oleifera woodland operations in the production process of the camellia oil, and the detailed inventory is used for carbon footprint accounting of the product of the camellia oil, and assessment of greenhouse gas in a life cycle of economic forest; a coverage of the assessment is from the cradle to the woodland gate, including: material and chemical inputs, electricity and fuel consumption, labors, and transportation of inputs and products of a woodland and its suppliers, but the coverage of the assessment does not include productions of capital equipment and facilities for management operations of the woodland;
in which, a function unit of the afforestation subsystem is one kilogram of the fresh camellia oleifera fruits; and
in which, the system boundary of the afforestation subsystem is from a seedling nursery gate to the woodland gate, including direct and indirect inputs and outputs of raw material collection, land preparation, camellia oleifera woodland management, and camellia oleifera fruit collection.

In an embodiment, for the crude camellia oil subsystem, an objective is to generate a detailed inventory for processing plant operations in the production process of the camellia oil, and the detailed inventory is used for carbon footprint accounting of the product of the camellia oil, and assessment of greenhouse gas in the life cycle of economic forest; a coverage of assessment is from the woodland gate to the oil mill gate, including: material and chemical inputs, electricity and fuel consumption, labors, and transportation of inputs and products of an oil mill and its suppliers;
in which, the function unit of the crude camellia oil subsystem is one ton of crude camellia oil; and
in which, the system boundary of the crude camellia oil subsystem is from the woodland gate to the oil mill gate, including direct and indirect inputs and outputs of raw material transportation, pre-treatment, camellia oil extraction and camellia oil refining.

In an embodiment, carbon footprint accounting is carried out for different inputs at each sub-phase, each process and each stage, the inputs include on-site energy, fertilizers, chemicals, materials, transportation and waste treatment;
in which, consumption of the on-site energy is expressed as the following formula (3):

$${E}_{Ene} = {E}_{Elec} + {E}_{Fuel} + {E}_{Lab} \qquad formula ( 3 )$$

where, E_{Ene} represents the CO₂ emissions corresponding to the energy consumed by the functional unit, E_{Elec} represents CO₂ emissions corresponding to electricity consumed by the functional unit, E_{Fuel} represents CO₂ emissions corresponding to fuel consumed by the functional unit, and E_{Lab} represents CO₂ emissions corresponding to labors consumed by the functional unit;
in which consumption of the electricity is expressed as the following formula (4):

$${E}_{Elec} = {G}_{Elec} \times {EF}_{Elec} \qquad formula ( 4 )$$

where, E_{Elec} represents the CO₂ emissions corresponding to the electricity consumed by the functional unit, G_{Elec} represents electricity consumed by the functional unit, and EF_{Elec} represents an emission factor of production of electricity;
in which, consumption of the fuel is expressed as the following formula (5):

$${E}_{Fuel} = {\sum }_{i} ( \frac{{U}_{mi} \times {T}_{m}}{{ef}_{m}} \times {Q}_{i} \times {EF}_{i} ) \qquad formula ( 5 )$$

where, E_{Fuel} represents the CO₂ emissions corresponding to the fuel consumed by the functional unit, Uₘᵢ represents consumption of a fuel i per unit time of a machine m, efₘ represents an energy conversion efficiency of the machine m, Tₘ represents a working duration of the machine m, EFᵢ represents an emission factor of the fuel i generating greenhouse gases, and Qᵢ represents an average net calorific value of the fuel i;
in which, consumption of the labors is expressed as the following formula (6):

$${E}_{Lab} = P \times D \times {EF}_{Lab} \qquad formula ( 6 )$$

where, P represents a number of workers, D represents a total number of working days, and EF_{Lab} represents a single-person single-day CO₂ emissions calculated by an energy method;
in which, consumption of the fertilizers is expressed as the following formula (7):

$${E}_{fer} = {\sum }_{i} ( {A}_{i} \times {M}_{i} \times {f}_{i} \times {EF}_{i} ) \qquad formula ( 7 )$$

where, E_{fer} represents the CO₂ emissions corresponding to the fertilizers consumed by the functional unit, Aᵢ represents an application area of a fertilizer i, Mᵢ represents an amount of the fertilizer i applied per unit area per time, fᵢ represents average fertilization times of the fertilizer i, and EFᵢ represents an emission factor of the fertilizer i generating greenhouse gases;
in which, consumption of the chemicals is expressed as the following formula (8):

$${E}_{cha} = {\sum }_{i} ( {AD}_{i} \times {EF}_{i} ) \qquad formula ( 8 )$$

where, E_{cha} represents the CO₂ emissions corresponding to the chemicals consumed by the functional unit, ADᵢ represents activity usage data of a chemical i, and EFᵢ represents an emission factor of the chemical i generating greenhouse gases;
in which, consumption of the materials is expressed as the following formula (9):

$${E}_{mat} = {\sum }_{i} ( {AD}_{i} \times {EF}_{i} ) \qquad formula ( 9 )$$

where Eₘₐₜ represents the CO₂ emissions corresponding to the materials consumed by the functional unit, ADᵢ represents activity usage data of a material i, and EFᵢ represents an emission factor of the material i generating greenhouse gases;
in which, transportation is expressed as the following formula (10):

$${E}_{T} = {M}_{T} \times {G}_{T} \times {EF}_{T} \qquad formula ( 10 )$$

where E_{T} represents the CO₂ emissions corresponding to the electricity consumed by the functional unit, M_{T} represents a transportation weight of the functional unit, G_{T} represents a transportation distance of the functional units, and EF_{T} represents an emission factor of production of transportation; and
in which waste treatment is expressed as the following formula (11):

$${E}_{Was} = {L}_{p} \times {W}_{i} \times {EF}_{L} + {I}_{p} \times {W}_{i} \times {EF}_{P} \qquad formula ( 11 )$$

where, E_{was} represents the carbon footprint during the waste treatment process; Lₚ represents a proportion of a waste landfill treatment, lₚ represents a proportion of a waste incineration treatment, Wᵢ represents a weight of a waste i, EF_{L} represents an emission factor of the waste landfill treatment, and EFₚ represents an emission factor of the waste incineration treatment.

In an embodiment, in the step (f), the conducting uncertainty and sensitivity analyses to determine emission proportions and data quality include: identifying variable factors, designing experimental schemes, determining activity data and carbon emission factors, conducting experiments, analyzing results, interpreting results, and drawing conclusions.

In an embodiment, the performing carbon balance consideration includes: assessing carbon absorption, calculating net carbon emissions, formulating emission reduction and carbon sequestration measures, realizing carbon balance, and monitoring and tracking.

In an embodiment, in the step (a), the trade-off criteria include: mass threshold excluding materials or processes that contributes less than 1% of total mass inputs or outputs in a subsystem, energy threshold excluding energy sources that contributes less than 2% of total energy consumption in the life cycle of the production process of the camellia oil, environmental significance including processes with disproportionately high emission factors even though physical quantities of the processes are small; data availability excluding processes with insufficient or unreliable data and replacing the processes with industry-average values or proxy data, economic impact excluding processes with negligible economic relevance to the functional unit, and regulatory compliance mandatorily including processes specified by international standards or local regulations.

In an embodiment, in the step (c), the allocation procedure is used to distribute resource consumption or carbon emissions reasonably among subsystems, stages or input categories, including following methods: energy consumption is apportioned according to operating time or equipment power share (e.g. when a machine runs 60% in time in pre-treatment and 40% in camellia oil refining, electricity consumption of the machine is allocated accordingly); fuel consumption is allocated according to power ratio (e.g. when a diesel generator represents 30% of total power of a subsystem, 30% of emissions caused by fuel consumption of the diesel generator are assigned to the subsystem); multi-output allocation divides co-product emissions according to mass or economic value (e.g. in a camellia seed pressing that yields camellia oil and seed cake, when the camellia oil accounts for 85% of total mass, then 85% of carbon emissions caused by the camellia seed pressing is attributed to a camellia oil subsystem); transportation allocation is based on ton-kilometer (e.g. when a batch of raw material is transported 100 kilometers (km 0 and 70% in weight of the raw material is destined for the afforestation subsystem and 30% goes to the crude camellia oil subsystem, emissions caused by a raw material transportation is split 70:30); and waste-treatment allocation weights emission factors according to disposal route (e.g. when 60% of waste is landfilled and 40% incinerated, an overall factor is computed as a 60:40 weighted average).

In an embodiment, in the step (c), the data requirement defines input data types, sources, and precision needed for carbon footprint accounting, including: energy data (electricity, diesel, gasoline) drawn from annual State Grid metering records (with a unit of kilowatt-hour (kWh)) and on-site machinery fuel logs (with a unit of liter per hour (L/h)), with electricity accurate to 0.1 kWh and fuel accurate to 0.1 liters (L) with error≤±2%; agricultural input data (fertilizer, pesticide, herbicide) sourced from woodland management records detailing application area (with a unit of hectare (ha)) and rate (with a unit of kilogram per hectare (kg/ha)) and from supplier composition sheets (ratio of nitrogen to phosphorus (P) and to sulfur), accurate to 1 kg/ha with application frequency noted, labor data (worker count, workdays) taken from timesheets (e.g. 5 workers×±30 days) of the afforestation subsystem and processing-plant schedules, specifying daily hours (e.g. 8 h/person/day) with error≤±5%, transportation data (weight in ton, distance in km, vehicle type) provided by logistics waybills (e.g. 10 tons of seeds over 200 km) and emission-factor databases (e.g. diesel truck at 0.15 kilograms (kg) carbon dioxide equivalent per ton per kilometer (CO₂e/t/km)), with distance accurate to 1 km and weight error≤±1%; and emission-factor libraries from Intergovernmental Panel on Climate Change (IPCC), regional grids or industry sources (e.g. 0.6 kg carbon dioxide equivalent per kilowatt-hour (CO₂e/kWh) for grid power, 1.2 kg carbon dioxide equivalent per kilogram (CO₂e/kg) for urea from Ecoinvent), updated every two years. Data sources must be authoritative and traceable.

In an embodiment, the carbon footprint accounting method for the production process of the camellia further includes: producing a carbon label based on the emission proportions, and pasting the carbon label on a package (e.g. a bottle) of the product of the camelia oil. For example, the carbon label may contain carbon emissions and accounting scope.

The disclosure has the following beneficial effects.

Compared with available patents of life cycle assessment of agricultural and forestry products, a method for constructing an emission inventory in a life cycle in the disclosure is more detailed and comprehensive. Carbon emissions of each production stage is finely divided, making the emission inventory more detailed and practical, and providing decision makers with more comprehensive carbon footprint data. Calculation of environmental costs is performed by in-depth analysis of the environmental costs at each stage, including energy, materials, and emissions during production process, therefore making the calculation of environmental costs more comprehensive, providing decision makers with more detailed economic and environmental information and contributing to more sustainable economic development. Carbon emission accounting of a supply chain is performed by in-depth understanding of carbon emissions in all stages of the supply chain, covering from raw material procurement to final product delivery, therefore making emission data more accurate, and facilitating comprehensively optimizing the supply chain and reducing overall carbon footprint.

### BRIEF DESCRIPTION OF DRAWINGS

FIG. 1 illustrates a schematic flowchart of a carbon footprint accounting method for a production process of camellia oil from afforestation to crude camellia oil.

FIG. 2 illustrates a schematic diagram of a boundary of a carbon footprint accounting system for the production process of the camellia oil from the afforestation to the crude camellia oil.

FIG. 3 illustrates a schematic diagram of a boundary of an afforestation subsystem.

FIG. 4 illustrates a schematic diagram of a boundary of a crude camellia oil subsystem.

### DETAILED DESCRIPTION OF EMBODIMENTS

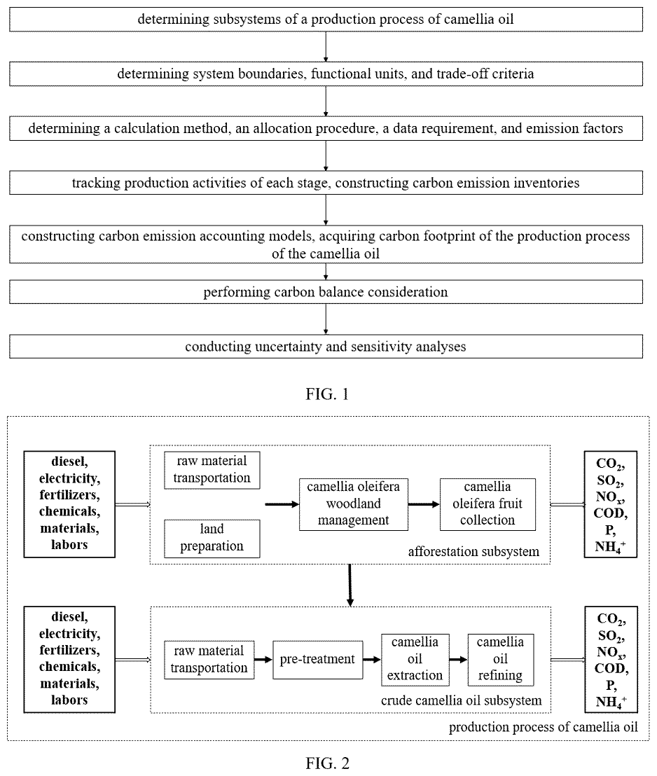

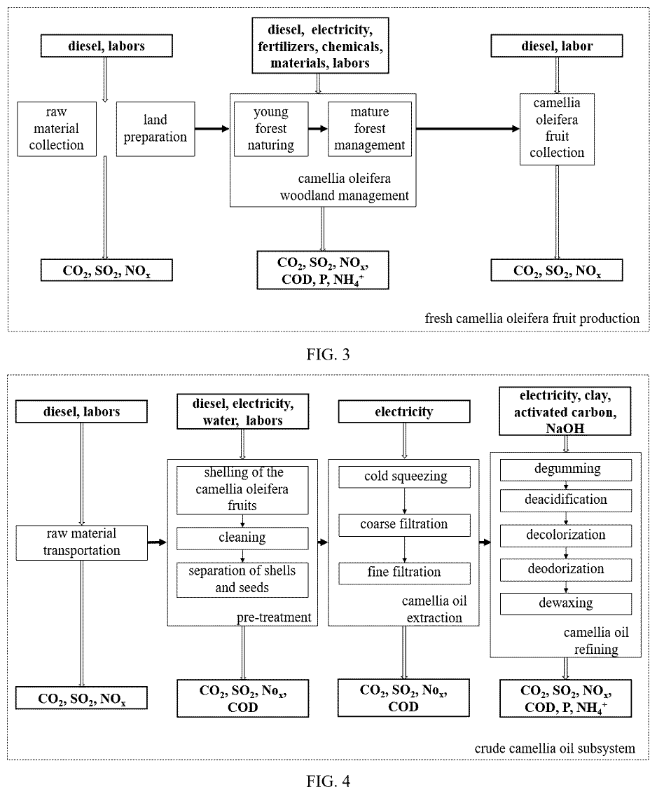

Technical solutions of the disclosure will be clearly and completely described with reference to FIG. 1-FIG. 4 of the embodiments according to the disclosure. Apparently, the described embodiments are just part of embodiments of the disclosure, not all of them. Unless otherwise indicated, technical means adopted in the embodiments are available means well known to those skilled in the art.

The disclosure discloses a carbon footprint accounting method for a production process of camellia oil. The carbon footprint accounting method for the production process of the camelia oil divides the production process of the camellia oil into an afforestation subsystem and a crude camellia oil subsystem and classifies inputs categories into energy, fertilizers, chemicals, materials, transportation, and waste treatment. The carbon footprint accounting method for the production process of the camellia oil accurately analyzes a carbon emission inventory throughout an entire life cycle of the production process of the camellia oil and precisely defines a system boundary for carbon footprint accounting, therefore laying a foundation for subsequent carbon footprint accounting and facilitating an accurate calculation of carbon footprint of each subsystem. Then after collecting an inputs categories data of each subsystem, the carbon footprint of each subsystem is calculated to be cumulatively summed to obtain a whole carbon footprint of the entire life cycle of the production process of the camellia oil. Finally, carbon footprint of crude camellia oil per unit mass in the entire life cycle of the production process of the camellia oil is calculated by counting a mass of the camellia oil produced.

The carbon footprint accounting method for the production process of the camellia oil, involves stages from afforestation to crude camellia oil, including the following steps.

(a) Subsystems are divided and system boundaries, functional unit, and trade-off criteria for a carbon footprint is determined in a life cycle of the production process of the camellia oil.

(b) Carbon emission inventories of the respective subsystems is determined based on production information of the production process of the camellia oil. The carbon emissions inventories in the life cycle of the production process of the camellia oil are analyzed. An input inventory and an output inventory for each of phases are determined.

(c) A calculation method, an allocation procedure, a data requirement, and emission factors of each of the subsystems are determined.

(d) Experiments are conducted, carbon balance consideration is performed, and carbon emissions and carbon sequestration are continuously monitored and tracked.

(e) Carbon emission accounting models are constructed by using an emission factor method, and the carbon footprint of the production process of the camellia oil is obtained by using the carbon emission accounting models of the respective subsystems.

(f) Uncertainty and sensitivity analyses are conducted to determine emission proportions and data quality.

The disclosure relates to a carbon footprint accounting method of two subsystem, including the afforestation subsystem and the crude camellia oil subsystem.

The afforestation subsystem refers to an efficient and sustainable production system achieved by optimizing and integrating stages of planting, naturing and camellia oleifera fruit harvesting by using scientific management and optimization measures. The afforestation subsystem has characteristics of (i) difficulties in long-term data collection, (ii) natural interference factors, (iii) high geographical heterogeneity, and (iv) dynamic changes in carbon storage.

The crude camellia oil subsystem refers to a process of extracting crude camellia oil from camellia seeds during the production process of the camellia oil, including a series of mechanical and physical operations to ensure high-quality of camelia oil output. The crude camellia oil subsystem has characteristics of (i) complex life cycle stages, (ii) diverse energy consumption, (iii) high regional differences, and (iv) dynamic changes in technology management.

In an embodiment, the life cycle of the production process of the camellia oil refers to all processes from camellia oleifera planting to crude camellia oil outcome, including the afforestation subsystem from a cradle to a woodland gate, and the crude camellia oil subsystem from the woodland gate to an oil mill gate, that is, system boundaries mentioned in the step (a).

The afforestation subsystem includes a production process of fresh camellia oleifera fruits from the cradle to the woodland gate, including four stages namely a preparation and planting stage, a young forest nurturing stage, a mature forest management stage and a camellia oleifera fruit harvesting stage, and the four stages are described in detail as follows.

(i) The preparation and planting stage is an initial stage of camellia oleifera woodland establishment, mainly including steps of site selection, soil preparation, seedling selection and planting. An objective of the preparation and planting stage is to provide best environmental conditions for growth of camellia oleifera trees. The preparation and planting stage includes five specific contents of woodland clearing, pit digging, base fertilizer application and pit refilling, camellia oleifera tree planting, and camellia oleifera tree replanting.

(ii) The young forest nurturing stage is an initial stage of the growth of the camellia oleifera trees, that is, woodland management lasting for one to five years. In the young forest nurturing stage, the camellia oleifera trees require meticulous management and care to ensure healthy growth of seedlings and establishment of a good forest stand structure. The young forest nurturing stage includes four specific contents of topdressing, pit expanding, complete understory clearance and pest control.

(iii) The mature forest management stage is a full-bearing period management and lasts for fifty years. The mature forest management stage includes three specific contents of topdressing, pruning and shaping, and pest and disease control.

(iv) The camellia oleifera fruit harvesting stage is a final stage of the camellia oleifera woodland establishment. The camellia oleifera fruit harvesting stage includes steps of camellia oleifera fruit harvesting, primary treatment and transportation.

The crude camellia oil subsystem includes the production process of the camellia oil from the woodland gate to the oil mill gate, including three stages namely a pre-treatment stage, a camellia oil extraction stage and a camellia oil refining stage, and the three stages are described in detail as follows.

(i) The pre-treatment stage is a primary processing of the camellia oleifera fruits harvested from the camellia oleifera woodland to prepare for subsequent camellia oil extraction stage. An objective of the pre-treatment stage is to remove impurities from the camellia oleifera fruits and bring the camellia oleifera fruits to a state suitable for the camellia oil extraction and to obtain pre-treated camellia seeds. The pre-treatment stage includes five specific contents of impurities removal, drying, shelling of the camellia oleifera fruits, cleaning, and separation of shells and seeds.

(ii) The camellia oil extraction stage is a process of extracting camellia oil from the pre-treated camellia seeds through mechanical and physical means. The camellia oil extraction stage is a core step in the production process of the camellia oil and determines quality and a yield of the crude camellia oil. The camellia oil extraction stage includes three specific contents of cold squeezing, coarse filtration, and fine filtration.

(iii) The camellia oil refining stage is a further process of the crude camellia oil to improve purity and the quality of the camellia oil and make the camellia oil meet needs of market and consumers. An objective of the camellia oil refining stage is to remove impurities, pigments and odors from the crude camellia oil and ensure quality and safety of the camellia oil. The camellia oil refining stage includes five specific contents of degumming, deacidification, decolorization, deodorization, dewaxing (winterization).

In an embodiment, for the afforestation subsystem, an objective is to generate a detailed inventory for camellia oleifera woodland operations in the production process of the camellia oil. The detailed inventory is used for carbon footprint accounting of a product of the camellia oil and assessment of greenhouse gas in a life cycle of economic forest. A coverage of the assessment is from the cradle to the woodland gate, including: materials and chemicals inputs, electricity and fuel consumption, labors, and transportation of inputs and products of a woodland and its suppliers. The coverage of the assessment does not include productions of capital equipment and facilities for woodland management operations of the camellia oleifera woodland. The function unit of the afforestation subsystem is one kilogram of the fresh camellia oleifera fruits. In a subsystem of production of the fresh camellia oleifera fruits, a process of camellia oleifera woodland management and the camellia oleifera fruit harvesting stage have a certain proportion of losses. The proportion of losses need to be set according to actual production situation. A system boundary of the afforestation subsystem is defined from a seedling nursery gate to the woodland gate, including direct and indirect inputs (electricity, fuel, chemicals, materials and labors) and outputs (carbon dioxide (CO₂); sulfur dioxide (SO₂); nitrogen oxides (NOₓ); chemical oxygen demand (COD); P; and ammonium ion (NH₄⁺)) of raw material collection, land preparation, camellia oleifera woodland management, and camellia oleifera fruit collection.

For the crude camellia oil subsystem, an objective is to generate a detailed inventory for processing plant operations in the production process of the camellia oil; and the detailed inventory is used for carbon footprint accounting of the product of the camellia oil and assessment of greenhouse gas in the life cycle of economic forest. A coverage of the assessment is from the woodland gate to the oil mill gate, including: material and chemical inputs, electricity and fuel consumption, and transportation of inputs and products of an oil mill and its suppliers. The coverage of the assessment does not include life cycle stages of distribution, consumption and scrapping, because products leaving the oil mill gate are not recorded, and scrapping options of packaging are different according to behavior habits of end consumers. All production, maintenance and cleaning, management processes of equipment, building cleaning and quality control processes are excluded from the disclosure. The function unit of the crude camellia oil subsystem is the one ton of crude camellia oil. In a system of production of the camellia oil, processes of storage, transportation, shelling and camellia oleifera seeds production of the fresh camellia oleifera fruits have a certain proportion of losses. The proportion of losses need to be set according to actual production situation. A system boundary of the crude camellia oil subsystem is defined from the woodland gate to the oil mill gate, including direct and indirect inputs (electricity, chemicals, water, materials and labors) and outputs (CO₂, SO₂, NOₓ, COD, P, NH₄⁺) of raw material transportation, the pre-treatment (shelling of the camellia oleifera fruits, cleaning, and separation of shells and seeds), the camellia oil extraction (cold squeezing, coarse filtration, and fine filtration) and the camellia oil refining (degumming, deacidification, decolorization, deodorization, dewaxing).

The production process of the camellia oil covers the afforestation subsystem and the crude camellia oil subsystem, and involves a series of resource allocation problems. The inputs include energy, fertilizers, chemicals, materials, products, and transportation. Allocation process of the inputs is a basis for constructing inventory for the entire life cycle of the production process of the camellia oil. The production process of the camellia oil involves a use of a large number of mechanical equipment and consumes a variety of energy sources, including electricity and fuel oil. In the disclosure, carbon emissions caused by using labors are also included in energy consumption. Consumption and allocation of the energy have an important influence on carbon footprint accounting of the energy of the production process of the camellia oil. Allocation of fertilizers and chemicals have influence on carbon footprint accounting of fertilizers and chemicals of the production process of the camellia oil. In the entire life cycle of the production process of the camellia oil, consumption of fertilizers and chemicals plays an important role in improving soil fertility, controlling pests and diseases, and improving yield and quality. Production and application processes of both chemicals and organic fertilizers generate significant amount of greenhouse gas emissions. Allocation of materials, including forestry production materials such as ground cloth and plastic film, need to be precisely and reasonably allocated, managed and recorded to perform carbon footprint accounting of the materials of the production process of the camellia oil. Allocation of transportation has influence on a carbon footprint accounting of the transportation of the production process of the camellia oil. The transportation of materials plays an important role in the entire life cycle of the production process of the camellia oil. Efficient and low-cost transportation requires reasonable planning and coordination. Carbon footprint of the transportation is also an important component of the carbon footprint of the entire life cycle of the production process of the camellia oil.

In the step (c), the calculation method includes a sum of environmental costs of all production subsystems, all production stages, and all input and output activities in the life cycle of the production process of the camellia oil. The environmental costs are converted into a total emission of carbon dioxide equivalent (CO₂e) or emissions of one functional unit, as per the following formula (1) and formula (2):

$$E = {\sum }_{i} ( {G}_{i} \times {EF}_{ij} ) \qquad formula ( 1 )$$

where, E represents emissions of a greenhouse gas j of the functional unit (kilogram (kg) CO₂e), Gᵢ represents activity usage data of an input i (kg, kWh; cubic meter (m³)), and EFᵢⱼ represents an emission factor of the input i generating the greenhouse gas j (kgCO₂e/kg); and

$$CF = {\sum }_{i} ( {E}_{i} \times {GWP}_{j} ) \qquad formula ( 2 )$$

where, CF represents carbon footprint of the functional unit (kgCO₂e), Eⱼ represents the emissions of the greenhouse gas j emissions of the functional unit (kgCO₂e), and
GWPⱼ represents a global warming potential value and is a coefficient that relates an impact of a unit mass of the greenhouse gas j at a given intensity of internal radiation to a radiation degree of effect of an equivalent mass of CO₂; a global warming potential (GWP) is a measure of how much infrared thermal radiation a greenhouse gas absorbs after being released into the atmosphere within a specific time frame and expressed as a multiple of radiation absorbed by an equivalent mass of carbon dioxide (CO₂); a calculation method of the GWPⱼ is to multiply the GWP by a mass of other gases. Based on the specifications established in the fourth assessment report 100-year time frame of the IPCC 2007, the GWP value is 25 for CH₄ and 298 for N₂O; and an impact assessment is limited to three main greenhouse gas emissions: CO₂, CH₄ and N₂O, because the disclosure merely assesses greenhouse gas emissions.

Carbon footprint accounting is carried out for different inputs at each sub-phase, process and stage, the inputs include on-site energy, fertilizers, chemicals, materials, transportation and waste treatment.

The on-site energy consumption is expressed as the following formula (3):

$${E}_{Ene} = {E}_{Elec} + {E}_{Fuel} + {E}_{Lab} \qquad formula ( 3 )$$

where, E_{Ene} represents CO₂ emissions corresponding to the energy consumed by the functional unit (kgCO₂ per functional unit (FU));
E_{Elec} represents CO₂ emissions corresponding to the electricity consumed by the functional unit (kgCO₂/FU);
E_{Fuel} represents CO₂ emissions corresponding to the fuel consumed by the functional unit (kgCO₂/FU); and
E_{Lab} represents CO₂ emissions corresponding to labors consumed by the functional units (kgCO₂/FU).

Consumption of electricity is obtained from daily electricity consumption recorded in the State Grid and internal records of production units. All stages of the production process of the camellia oil consume electricity, but it is impossible to distinguish the electricity consumed in each activity. The consumption of the electricity includes electricity consumed by seed cold storages, irrigation equipment, motorized forklifts, peeling equipment, industrial air-conditioning, product preservation, office equipment and industrial plant lighting, optimum temperatures. The consumption of the electricity is expressed as the following formula (4):

$${E}_{Elec} = {G}_{Elec} \times {EF}_{Elec} \qquad formula ( 4 )$$

where, E_{Elec} represents CO₂ emissions corresponding to the electricity consumed by the functional unit (kgCO₂/FU);
G_{Elec} represents electricity consumed by the functional units (kWh);
and EF_{Elec} represents an emission factor of production of electricity (kgCO₂/kWh).

Consumption of the fuel, including diesel oil and gasoline consumed by all facilities and equipment on production sites, is expressed as the following formula (5):

$${E}_{Fuel} = {\sum }_{i} ( \frac{{U}_{ma} \times {T}_{m}}{{ef}_{m}} \times {Q}_{i} \times {EF}_{i} ) \qquad formula ( 5 )$$

where, E_{Fuel} represents the CO₂ emissions corresponding to the fuel consumed by the functional unit (kgCO₂/FU);
Uₘᵢ represents consumption of a fuel i per unit time of a machine m, with a unit of liter per hour (L/h);
efₘ represents an energy conversion efficiency of the machine m;
Tₘ represents a working duration of the machine m, with a unit of hour (h);
EFᵢ represents an emission factor of the fuel i generating greenhouse gases, with a unit of kilogram carbon dioxide equivalent per kilojoule (kgCO₂e/KJ); and
Qᵢ represents an average net calorific value of the fuel i, with a unit of kilojoule per liter (Kj/L).

Consumption of the labors, determined based on records of the woodland management and work records of the oil mill work records, is expressed as the following formula (6):

$${E}_{Lab} = P \times D \times {EF}_{Lab} \qquad formula ( 6 )$$

where P represents a number of workers;
D represents a total number of working days; and
EF_{Lab} represents a single-person single-day CO₂ emissions calculated by an energy method, with a unit of kilogram carbon dioxide equivalent per person per day (kgCO₂/(person-day).

Consumption of the fertilizers, including fertilizers applied in the camellia oil production and fresh camellia oleifera fruits production, is expressed as the following formula (7):

$${E}_{fer} = {\sum }_{i} ( {A}_{i} \times {M}_{i} \times {f}_{i} \times {EF}_{i} ) \qquad formula ( 7 )$$

where, E_{fer} represents CO₂ emissions corresponding to the fertilizers consumed by the functional unit (kgCO₂/FU);
Aᵢ represents an application area of a fertilizer i, with a unit of hectare (ha);
Mᵢ represents an amount of the fertilizer i applied per unit area per time, with a unit of kilogram per hectare per time (kg/ha/time);
fᵢ represents average fertilization times of the fertilizer i, with a unit of time; and
EFᵢ represents an emission factor of the fertilizer i generating greenhouse gases, with a unit of (kgCO₂e/kg).

Consumption of the chemicals, including pesticide spraying, herbicide use, disinfectant use and production use, is expressed as the following formula (8):

$${E}_{cha} = {\sum }_{i} ( {AD}_{i} \times {EF}_{i} ) \qquad formula ( 8 )$$

where, E_{cha} represents CO₂ emissions corresponding to the chemicals consumed by the functional unit (kgCO₂/FU);
ADᵢ represents activity usage data of a chemical i, with a unit of kg; and
EFᵢ represents an emission factor of the chemical i generating greenhouse gases, with a unit of kgCO₂e/kg.

Consumption of the materials is expressed as the following formula (9):

$${E}_{mat} = {\sum }_{i} ( {AD}_{i} \times {EF}_{i} ) \qquad formula ( 9 )$$

where Eₘₐₜ represents CO₂ emissions corresponding to the materials consumed by the functional unit (kgCO₂/FU);
ADᵢ represents activity usage data of a material i, with a unit of kg; and
EFᵢ represents an emission factor of the material i generating greenhouse gases, with a unit of kgCO₂e/kg.

Transportation, including a transportation from upstream raw materials to the production site and a transportation from produced products to a next system, is expressed as the following formula (10):

$${E}_{T} = {M}_{T} \times {G}_{T} \times {EF}_{T} \qquad formula ( 10 )$$

where E_{T} represents CO₂ emissions corresponding to the electricity consumed by the functional unit (kgCO₂/FU);
M_{T} represents a transportation weight of the functional units (ton (t));
G_{T} represents a transportation distance of the functional units (kilometer (km)); and
EF_{T} represents an emission factor of production of transportation (kilogram carbon dioxide equivalent per ton per kilometer (kgCO₂e/(t-km)).

Waste treatment, selecting an appropriate emission factor for calculation according to different treatment methods, is expressed as the following formula (11):

$${E}_{Was} = {L}_{p} \times {W}_{i} \times {EF}_{L} + {I}_{p} \times {W}_{i} \times {EF}_{P} \qquad formula ( 11 )$$

where, E_{Was} represents a carbon footprint of during a waste treatment process;
Lₚ represents a proportion of a waste landfill treatment;
Iₚ represents a proportion of a waste incineration treatment;
Wᵢ represents a weight of a waste i;
EF_{L} represents an emission factor of the waste landfill treatment, and EFₚ represents an emission factor of the waste incineration treatment.

In the step (e), the carbon emission accounting models for two subsystems namely the afforestation subsystem and the crude camellia oil subsystem are constructed respectively, and carbon footprints accountings of the two subsystems are conducted.

Carbon footprint of the afforestation subsystem includes a total amount of greenhouse gas emissions caused by consumption of environmental resources and energy in all production processes within the afforestation subsystem expressed as the following formula (12):

$${E}_{forest} = \frac{{E}_{Ene} + {E}_{fer} + {E}_{cha} + {E}_{mat} + {E}_{T} + {E}_{was}}{( 1 - {W}_{1} )} \qquad formula ( 12 )$$

where, E_{forest} represents the carbon footprint of the afforestation subsystem, W₁ represents a loss rate of the afforestation subsystem.

A carbon footprint of the crude camellia oil subsystem includes a total amount of greenhouse gas emissions caused by consumption of environmental resources and energy in all production processes within the crude camellia oil subsystem expressed as the following formula (13):

$${E}_{oil} = \frac{{E}_{Ene} + {E}_{fer} + {E}_{cha} + {E}_{mat} + {E}_{T} + {E}_{was}}{( 1 - {W}_{2} )} \qquad formula ( 13 )$$

where Eₒᵢₗ represents the carbon footprint of the crude camellia oil subsystem, and W₂ represents a loss rate of the crude camellia oil subsystem.

For the camellia oil, carbon footprint for the product of the camellia oil includes a total amount of greenhouse gas emissions caused by consumption of environmental resources and energy during a process of producing one ton of crude camellia oil (i.e., a functional unit) expressed as the following formula (14):

$${E}_{FU} = \frac{{E}_{total}}{P} \qquad ( 14 )$$

where E_{FU} represents a carbon footprint of one functional unit;
Eₜₒₜₐₗ represents total carbon footprint of the production process of the camellia oil; and
P represents a total mass of product of camellia oil.

In an embodiment, the conducting uncertainty and sensitivity analyses, to determine emission proportions and data quality, is to count activity data that has important influence on carbon footprint accounting of the production process of the camellia oil, and to understand their interaction and comprehensive influence on carbon footprint, including identifying variable factors, designing experimental schemes, determining activity data and carbon emission factors, conducting experiments, analyzing results, interpreting results, and drawing conclusions.

The identifying variable factors is to identify key variable factors that may influence the carbon footprint.

The designing experimental schemes is to select orthogonal experimental design.

The determining activity data and carbon emission factors is to collect the activity data involved in each stage and each phase, and to establish a carbon emission factor library.

The conducting experiments is to, based on an experimental scheme, conduct experiment on different levels of each of the variable factors and record experiment result.

The analyzing results is to, by using a statistical analysis method, assess an influence of each of the variable factors on the carbon footprint.

The interpreting results is to interpret an extent of the influence of each of the variable factors on the carbon footprint.

The drawing conclusions is to, based on statistical analysis and results interpretation, determine the variable factors that have important influence on the carbon footprint, and to propose optimization measures and management strategies.

Since there is a carbon sequestration process in a system output, carbon balance consideration needs to be conducted. A step for conducting carbon balance consideration includes assessing carbon absorption, calculating net carbon emissions, formulating emission reduction and carbon sequestration measures, realizing carbon balance, and monitoring and tracking.

The assessing carbon absorption is to determine an amount of carbon sequestration in system or activity through experiments, including carbon absorption through activities of afforestation, forest management, and soil carbon sequestration.

The calculating net carbon emissions is to subtract the amount of carbon sequestration from an amount of the carbon emission to calculate the net carbon emissions of the system or activity. If the net carbon emissions is negative, it indicates that the carbon sequestration process exceeds carbon emissions, meaning the system or activity is a net carbon absorber.

The formulating emission reduction and carbon sequestration measures is to take emission reduction measures to reduce carbon emissions and to promote carbon sequestration measures to increase carbon sequestration if the net carbon emission is large.

The realizing carbon balance is to, by using the emission reduction measures and the carbon sequestration measures, make the net carbon emission close to zero to achieve carbon balance or carbon neutrality.

The monitoring and tracking are to continuously monitor the carbon emission and carbon sequestration, to ensure an efficiency of the emission reduction measures and the carbon sequestration measures, and to adjust strategies in time to achieve long-term carbon balance.

The above-mentioned embodiments are only part of embodiments of the disclosure, and do not limit a scope of the disclosure. All kinds of deformation, variation, modification and substitution of the technical solutions of the disclosure made by those skilled in the art without departing from the design spirit of the disclosure shall fall within the scope of protection claimed by the claims of the disclosure.

What is claimed is:

1. A carbon footprint accounting method for a production process of camellia oil, comprising following steps:
(a) dividing subsystems and determining system boundaries, functional units, and trade-off criteria for carbon footprint in a life cycle of the production process of the camellia oil;
(b) determining carbon emission inventories of the respective subsystems based on production information of the production process of the camellia oil, analyzing the carbon emission inventories in the life cycle of the production process of the camellia oil, and determining an input inventory and an output inventory for each of phases;
(c) determining a calculation method, an allocation procedure, a data requirement and emission factors of each of the subsystems,
wherein the calculation method comprises calculating total emissions of carbon dioxide equivalent (CO₂e) in the life cycle of the production process of the camellia oil as per the following formula (1) and formula (2):
$$E = {\sum }_{i} ( {G}_{i} \times {EF}_{ij} ) \qquad formula ( 1 )$$
where E represents emissions of a greenhouse gas j of the functional unit, Gᵢ represents activity usage data of an input i, and EFᵢⱼ represents an emission factor of the input i generating the greenhouse gas j,
$$CF = {\sum }_{i} ( {E}_{i} \times {GWP}_{j} ) \qquad formula ( 2 )$$
where CF represents carbon footprint of the functional unit, Eⱼ represents the emissions of the greenhouse gas j of the functional unit, and GWPⱼ represents a global warming potential;
(d) conducting experiments, performing carbon balance consideration, and continuously monitoring and tracking carbon emissions and carbon sequestration;
(e) constructing carbon emission accounting models by using an emission factor method, and obtaining the carbon footprint of the production process of the camellia oil by using the carbon emission accounting models of the respective subsystems; and
(f) conducting uncertainty and sensitivity analyses to determine emission proportions and data quality;
wherein the step (e) comprises constructing the carbon emission accounting models for two subsystems namely an afforestation subsystem and a crude camellia oil subsystem and conducting carbon footprint accountings as follows:
carbon footprint of the afforestation subsystem comprises a total amount of greenhouse gas emissions caused by consumption of environmental resources and energy in all production processes within the afforestation subsystem expressed as the following formula (12):
$${E}_{forest} = \frac{{E}_{Ene} + {E}_{fer} + {E}_{cha} + {E}_{mat} + {E}_{T} + {E}_{was}}{( 1 - {W}_{1} )} \qquad formula ( 12 )$$
where E_{forest} represents the carbon footprint of the afforestation subsystem, W₁ represents a loss rate of the afforestation subsystem, E_{Ene} represents carbon dioxide (CO₂) emissions corresponding to energy consumed by the functional unit, E_{cha} represents CO₂ emissions corresponding to chemicals consumed by the functional unit, Eₘₐₜ represents CO₂ emissions corresponding to materials consumed by the functional unit, Er represents CO₂ emissions corresponding to electricity consumed by the functional unit, E_{was} represents carbon footprint during a waste treatment process, and E_{fer} represents CO₂ emissions corresponding to fertilizers consumed by the functional unit;
carbon footprint of the crude camellia oil subsystem comprises a total amount of greenhouse gas emissions caused by consumption of environmental resources and energy in all production processes within the crude camellia oil subsystem expressed as the following formula (13):
$${E}_{oil} = \frac{{E}_{Ene} + {E}_{fer} + {E}_{cha} + {E}_{mat} + {E}_{T} + {E}_{was}}{( 1 - {W}_{2} )} \qquad formula ( 13 )$$
where Eₒᵢₗ represents the carbon footprint of the crude camellia oil subsystem, and W₂ represents a loss rate of the crude camellia oil subsystem; and
for the camellia oil, carbon footprint for a product of the camellia oil comprises a total amount of greenhouse gas emissions caused by consumption of environmental resources and energy during a process of producing one ton of crude camellia oil expressed as the following formula (14):
$${E}_{FU} = \frac{{E}_{total}}{P} \qquad formula ( 14 )$$
where E_{FU} represents carbon footprint of one functional unit, and Eₜₒₜₐₗ represents total carbon footprint of the production process of the camellia oil.

2. The carbon footprint accounting method for the production process of the camellia oil as claimed in claim 1, wherein in the step (a), the system boundaries comprise all processes in the life cycle of the production process of the camellia oil from camellia oleifera planting to crude camellia oil outcome, including: the afforestation subsystem from a cradle to a woodland gate, and the crude camellia oil subsystem from the woodland gate to an oil mill gate;
wherein the afforestation subsystem comprises a production process of fresh camellia oleifera fruits from the cradle to the woodland gate, including: a preparation and planting stage, a young forest nurturing stage, a mature forest management stage, and a camellia oleifera fruit harvesting stage; and
wherein the crude camellia oil subsystem comprises a production process of the camellia oil from the woodland gate to the oil mill gate, including: a pre-treatment stage, a camellia oil extraction stage, and a camellia oil refining stage.

3. The carbon footprint accounting method for the production process of the camellia oil as claimed in claim 2, wherein for the afforestation subsystem, an objective is to generate a detailed inventory for camellia oleifera woodland operations in the production process of the camellia oil, and the detailed inventory is used for carbon footprint accounting of the product of the camellia oil, and assessment of greenhouse gas in a life cycle of economic forest; a coverage of the assessment is from the cradle to the woodland gate, comprising: material and chemical inputs, electricity and fuel consumption, labors, and transportation of inputs and products of a woodland and its suppliers, but the coverage of the assessment does not comprise productions of capital equipment and facilities for management operations of the woodland;
wherein the function unit of the afforestation subsystem is one kilogram of the fresh camellia oleifera fruits; and
wherein the system boundary of the afforestation subsystem is from a seedling nursery gate to the woodland gate, comprising direct and indirect inputs and outputs of raw material collection, land preparation, camellia oleifera woodland management and camellia oleifera fruit collection.

4. The carbon footprint accounting method for the production process of the camellia oil as claimed in claim 2, wherein for the crude camellia oil subsystem, an objective is to generate a detailed inventory for processing plant operations in the production process of the camellia oil, and the detailed inventory is used for carbon footprint accounting of the product of the camellia oil, and assessment of greenhouse gas in the life cycle of economic forest; a coverage of the assessment is from the woodland gate to the oil mill gate, comprising: material and chemical inputs, electricity and fuel consumption, labors, and transportation of inputs and products of an oil mill and its suppliers;
wherein the function unit of the crude camellia oil subsystem is one ton of crude camellia oil; and
wherein the system boundary of the crude camellia oil subsystem is from the woodland gate to the oil mill gate, comprising direct and indirect inputs and outputs of raw material transportation, pre-treatment, camellia oil extraction and camellia oil refining.

5. The carbon footprint accounting method for the production process of the camellia oil as claimed in claim 1, wherein carbon footprint accounting is carried out for different inputs at each sub-phase, each process and each stage, the inputs comprise on-site energy, fertilizers, chemicals, materials, transportation and waste treatment;
wherein consumption of the on-site energy is expressed as the following formula (3):
$${E}_{Ene} = {E}_{Elec} + {E}_{Fuel} + {E}_{Lab} \qquad formula ( 3 )$$
where E_{Ene} represents the CO₂ emissions corresponding to the energy consumed by the functional unit, E_{Elec} represents CO₂ emissions corresponding to electricity consumed by the functional unit, E_{Fuel} represents CO₂ emissions corresponding to fuel consumed by the functional unit, and E_{Lab} represents CO₂ emissions corresponding to labors consumed by the functional unit;
wherein consumption of the electricity is expressed as the following formula (4):
$${E}_{Elec} = {G}_{Elec} \times {EF}_{Elec} \qquad formula ( 4 )$$
where E_{Elec} represents the CO₂ emissions corresponding to the electricity consumed by the functional unit, G_{Elec} represents electricity consumed by the functional unit, and EF_{Elec} represents an emission factor of production of electricity;
wherein consumption of the fuel is expressed as the following formula (5):
$${E}_{Fuel} = {\sum }_{i} ( \frac{{U}_{ma} \times {T}_{m}}{e {f}_{m}} \times {Q}_{a} ) \qquad formula ( 5 )$$
where E_{Fuel} represents the CO₂ emissions corresponding to the fuel consumed by the functional unit, Uma represents consumption of a fuel a per unit time of a machine m, efₘ represents an energy conversion efficiency of the machine m, Tₘ represents a working duration of the machine m, EFₐ represents an emission factor of the fuel a generating greenhouse gases, and Qₐ represents an average net calorific value of the fuel a;
wherein consumption of the labors is expressed as the following formula (6):
$${E}_{Lab} = P \times D \times {EF}_{Lab} \qquad formula ( 6 )$$
where P represents a number of workers, D represents a total number of working days, and EF_{Lab} represents a single-person single-day CO₂ emissions calculated by an energy method;
wherein consumption of the fertilizers is expressed as the following formula (7):
$${E}_{fer} = {\sum }_{i} ( {A}_{x} \times {M}_{x} \times {f}_{x} \times {EF}_{x} ) \qquad formula ( 7 )$$
where E_{fer} represents the CO₂ emissions corresponding to the fertilizers consumed by the functional unit, Aₓ represents an application area of a fertilizer x, Mₓ represents an amount of the fertilizer x applied per unit area per time, fₓ represents average fertilization times of the fertilizer x, and EFₓ represents an emission factor of the fertilizer x generating greenhouse gases;
wherein consumption of the chemicals is expressed as the following formula (8):
$${E}_{cha} = {\sum }_{i} ( {AD}_{x} \times {EF}_{x} ) \qquad formula ( 8 )$$
where E_{cha} represents the CO₂ emissions corresponding to the chemicals consumed by the functional unit, ADₓ represents activity usage data of a chemical x, and EFₓ represents an emission factor of the chemical x generating greenhouse gases;
wherein consumption of the materials is expressed as the following formula (9):
$${E}_{mat} = {\sum }_{i} ( {AD}_{x} \times {EF}_{x} ) \qquad formula ( 9 )$$
where Eₘₐₜ represents the CO₂ emissions corresponding to the materials consumed by the functional unit, ADₓ represents activity usage data of a material x, and EFₓ represents an emission factor of the material x generating greenhouse gases;
wherein transportation is expressed as the following formula (10):
$${E}_{T} = {M}_{T} \times {G}_{T} \times {EF}_{T} \qquad formula ( 10 )$$
where E_{T} represents the CO₂ emission corresponding to the electricity consumed by the functional unit, M_{T} represents a transportation weight of the functional unit, G_{T} represents a transportation distance of the functional unit, and EF_{T} represents an emission factor of production of transportation; and
wherein waste treatment is expressed as the following formula (11):
$${E}_{Was} = {L}_{p} \times {W}_{i} \times {EF}_{L} + {I}_{p} \times {W}_{i} \times {EF}_{P} \qquad formula ( 11 )$$
where E_{was} represents the carbon footprint during the waste treatment process, Lₚ represents a proportion of a waste landfill treatment, Iₚ represents a proportion of a waste incineration treatment, Wᵢ represents a weight of a waste i, EF_{L} represents an emission factor of the waste landfill treatment, and EFₚ represents an emission factor of the waste incineration treatment.

6. The carbon footprint accounting method for the production process of the camellia oil as claimed in claim 1, wherein in the step (f), the conducting uncertainty and sensitivity analyses to determine emission proportions and data quality comprises: identifying variable factors, designing experimental schemes, determining activity data and carbon emission factors, conducting experiments, analyzing results, interpreting results, and drawing conclusions.

7. The carbon footprint accounting method for the production process of the camellia oil as claimed in claim 1, wherein the performing carbon balance consideration comprises: assessing carbon absorption, calculating net carbon emissions, formulating emission reduction and carbon sequestration measures, realizing carbon balance, and monitoring and tracking.
